(19) United States
(12) Patent Application Publication
(10) Pub. No.: US 2025/0149809 A1
(43) Pub. Date: May 8, 2025

(54) ELECTRICAL CONNECTION STRUCTURE

(71) Applicant: GENERAL PLASTIC INDUSTRIAL CO., LTD., Taichung City (TW)

(72) Inventor: Yi-Chia WU, Taichung City (TW)

(73) Assignee: GENERAL PLASTIC INDUSTRIAL CO., LTD., Taichung City (TW)

(21) Appl. No.: 18/386,505

(22) Filed: Nov. 2, 2023

(51) Int. Cl. H01R 12/58; G03G 15/00; G03G 15/08

(52) U.S. Cl. CPC H01R 12/58; G03G 15/0865; G03G 15/80

(57) ABSTRACT

An electrical connection structure includes a substrate and a terminal. The substrate includes a through hole and at least one electrical contact provided at a wall of the through hole. The terminal includes two elastic arms spaced from each other, and a connection portion connected with the two elastic arms. The two elastic arms are abutted against the wall of the through hole and electrically connected with the at least one electrical contact. As a result, the electrical connection structure is not only stable in structure and positive in electrical connection, but also quick in assembly without the need of soldering, thereby achieving a high yield rate to reduce the manufacturing cost.

### BACKGROUND OF THE INVENTION

### 1. Field of the Invention

The present invention relates generally to an electronic apparatus and more particularly, to an electrical connection structure used in an electronic apparatus, such as a toner cartridge for an electronic image-forming apparatus.

### 2. Description of the Related Art

In conventional electrical connection structures, the soldering method is used to connect the terminals with the circuit traces of the circuit board. This conventional structure is reliable. However, in certain circumstances, such as the terminal sizes are small or the terminals are arranged crowded, the terminals may not be easily and accurately positioned at desired locations of the circuit board by jigs, resulting in labor-intensive and time-consuming soldering tasks and poor yield rate, which will greatly increase the manufacturing cost. Therefore, developing a convenient and reliable electrical connection way has become a challenge that the industry is striving to overcome.

### SUMMARY OF THE INVENTION

The present invention has been accomplished in view of the above-noted circumstances. It is an objective of the present invention to provide an electrical connection structure, which can be quickly assembled, and has a stable structure, good yield rate, and low manufacturing cost.

To attain the above-mentioned objective, the present invention provides an electrical connection structure comprising a substrate and a terminal. The substrate includes at least one through hole and at least one electrical contact provided at a wall of the through hole. The terminal includes two elastic arms spaced from each other, and a connection portion connected with the two elastic arms. The two elastic arms are abutted against the wall of the through hole and electrically connected with the at least one electrical contact. As a result, the electrical connection structure provided by the present invention is not only stable in structure and positive in electrical connection, but also quick in assembly without the need of soldering, thereby achieving a high yield rate to reduce the manufacturing cost.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view showing that an electrical connection structure according to a first embodiment of the present invention is applied to a toner cartridge:

FIG. 2 is an enlarged view of a part of FIG. 1;

FIG. 3 is an exploded perspective view of the electrical connection structure of the first embodiment of the present invention:

FIG. 4 is a front view of the electrical connection structure of the first embodiment of the present invention:

FIG. 5 is a perspective view of an electrical connection structure in accordance with a second embodiment of the present invention:

FIG. 6 is an exploded perspective view of the electrical connection structure of the second embodiment of the present invention; and

FIG. 7 is a front view of the electrical connection structure of the second embodiment of the present invention.

### DETAILED DESCRIPTION OF THE INVENTION

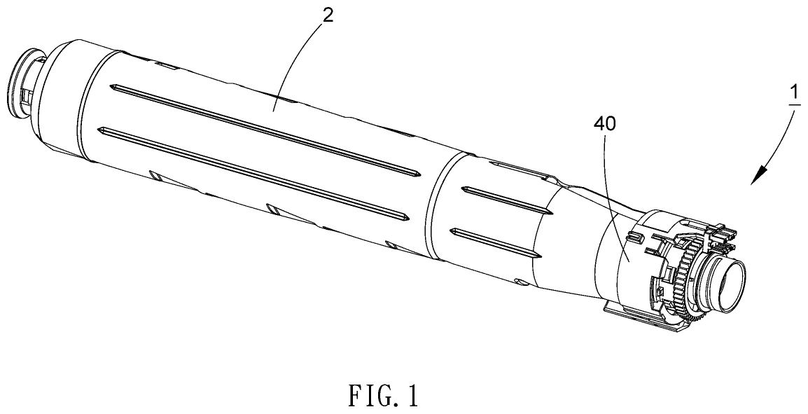

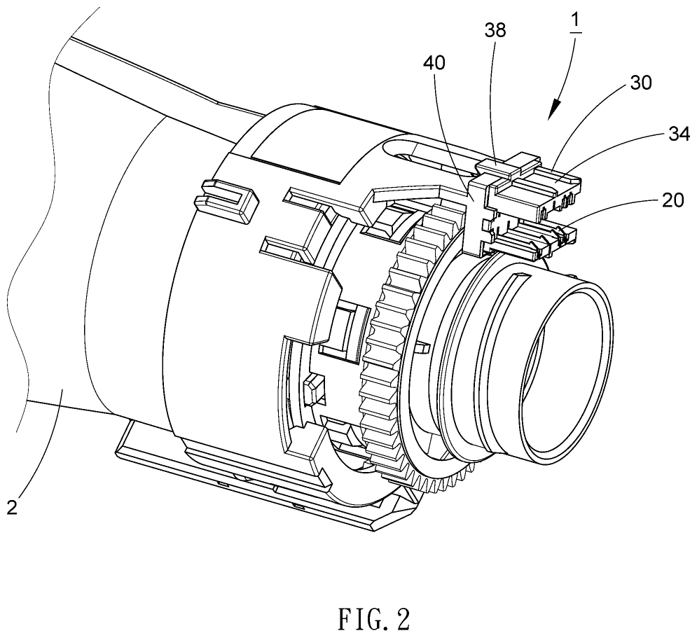

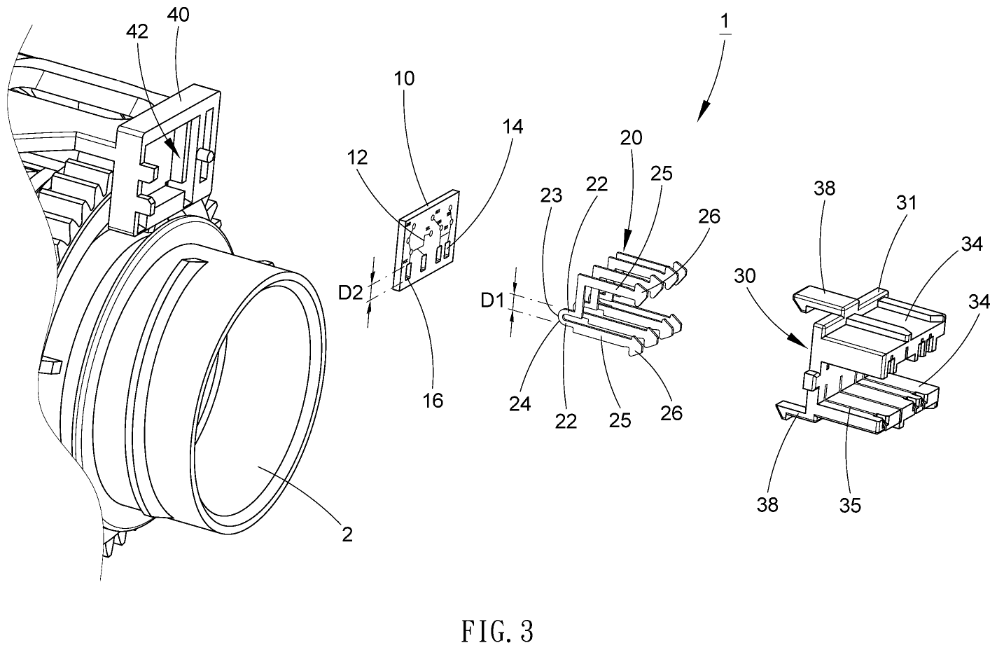

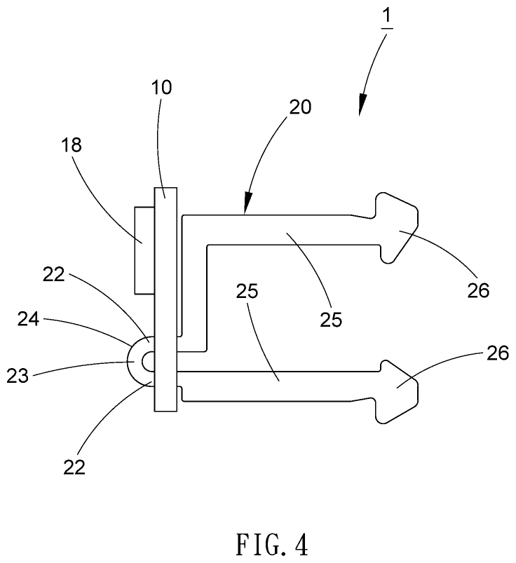

Hereunder two embodiments will be detailed described with accompanying drawings for illustrating technical features and structure of the present invention. FIGS. 1-4 depict an electrical connection structure 1 in accordance with a first embodiment of the present application, which is used to be installed to a toner cartridge 2 of an electronic image-forming apparatus (not shown), such as a printer, photocopier, etc. In another embodiment, the electrical connection structure 1 can be applied to other electronic apparatuses. In this embodiment, the electrical connection structure 1 is composed of a substrate 10, four terminals 20, a terminal mount 30, and a retaining mount 40.

The substrate 10 is provided with a plurality of circuit traces 12 and four through holes 14. The inner peripheral wall of each of the through holes 14 is provided with two electrical contacts 16 electrically connected with the circuit traces 12. Further, a memory 18 is provided on one side of the substrate 10 and electrically connected with the circuit traces 12. The memory 18 stores relevant information about the toner cartridge 2. In another embodiment, one or more electrical contacts 16 may be provided at the wall of each through hole 14.

The four terminals 20 are formed by sheet pieces and each include two elastic arms 22 spaced from each other, a connection portion 23 connected with the two elastic arms 22, two suspension arms 25 extending outwardly from the ends of the two elastic arms 22, and two contact ends 26 respectively provided at terminal ends of the two suspension arms 25 for being electrically and mechanically coupled with an electronic image-forming apparatus. The two elastic arms 22 are abutted against the inner peripheral wall of the through hole 14 and electrically connected with the electrical contacts 16. The connection portion 23 has an arched shape, and the two elastic arms 22 extend parallel to each other from the two ends of the connection portion 23, such that the two elastic arms 22 can be deformed to approach each other under force. The outer edges of the two conjunctions, to which the connection portion 23 and the two elastic arms 22 are connected, have two first arc guiding portions 24 to enable that the two elastic arms 22 can be inserted into the through hole 14 smoothly. Since the first distance D1 between the outer edges of the two elastic arms 22 is slightly larger than the second distance D2 between two opposite sides of the wall of the through hole 14, when the two elastic arms 22 are inserted through the through hole 14, the two elastic arms 22 and/or the connection portion 23 are slightly deformed, so that the two elastic arms 22 can be elastically pressed against the electrical contacts 16 by an elastic rebounding force. With this structural design, the electrical connection structure 1 of the present invention may have a stable structure, a positive, precise electrical connection without the need of soldering, and an enhanced yield rate. In another embodiment, one or more suspension arms 25 or contact ends 26 of the terminal 20 may be provided, or the structure of the terminal 20 may be modified, e.g., by omitting the two suspension arms 25.

The terminal mount 30 includes a base plate 31, two extension plates 34 extending parallel to each other from the base plate 31, a plurality of receiving grooves 35 provided at the two extension plates 34 and the base plate 31 to accommodate the suspension arms 25 of the terminals 20, and three elastic hook arms 38 extending parallel to each other from the base plate 31 in the direction opposite to the two extension plates 34. The terminal mount 30 fixes the relative positions of the terminals 20. When the terminal mount 30 approaches the substrate 10, the connection portions 23 of the terminals 20 can be correctly inserted through the through holes 14 and electrically connected with the electrical contacts 16. This not only enables rapid assembly but also eliminates the need to individually align and weld each terminal 20 with the through holes 14 and the electrical contacts 16 of the substrate 10, respectively. Since the actual alignment and welding processes are time-consuming and labor-intensive in the prior art, the present invention can effectively reduce manufacturing costs and enhance the yield rate.

The retaining mount 40 is sleeved onto the front end of the toner cartridge 2 and has a receiving space 42 for accommodating the substrate 10. When the terminal mount 30 is anchored with the retaining mount 40 by the elastic hook arms 38, the retaining mount 40 is connected to the terminal mount 30 in such a way that the substrate is sandwiched between the retaining mount 40 and the terminal mount 30. In this way, it can ensure that the elastic arms 22 of the terminals 20 positively extend through the 10 through holes 14 to achieve the electrical connections between the terminals 20 and the substrate 10. As such, the electrical connection structure 1 of the present invention may be more stable, and may be made with enhanced yield rate. In another embodiment, the terminal mount 30 can be connected to the retaining mount 40 by adhesive, snapping, or other means.

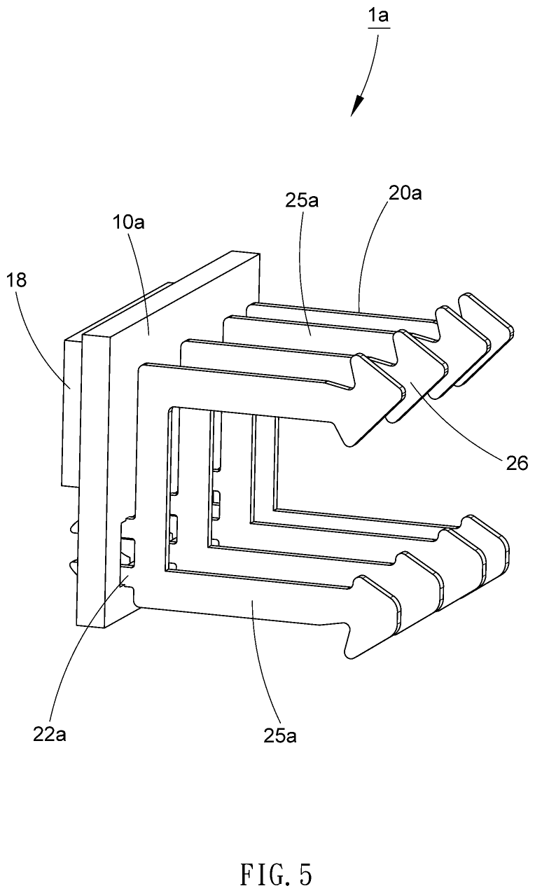

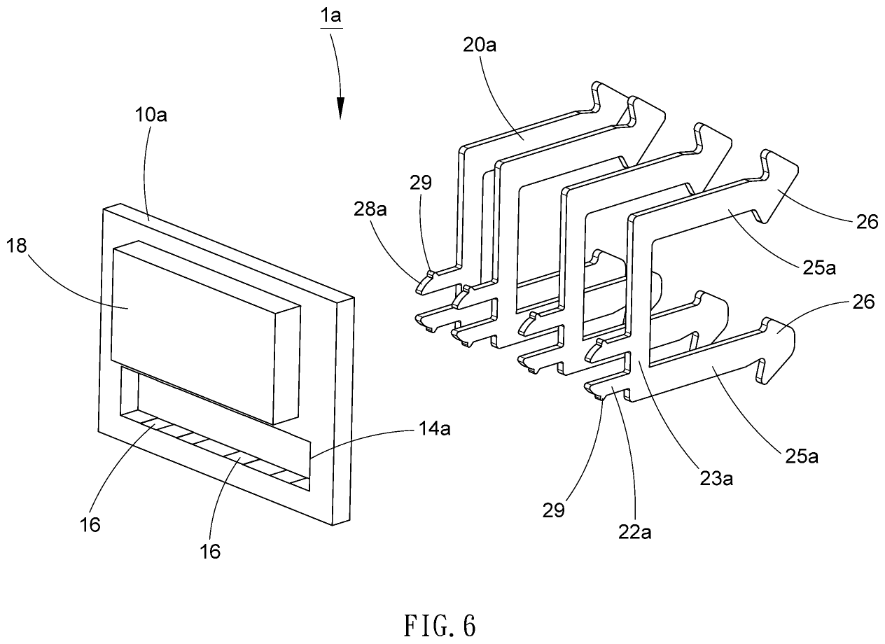

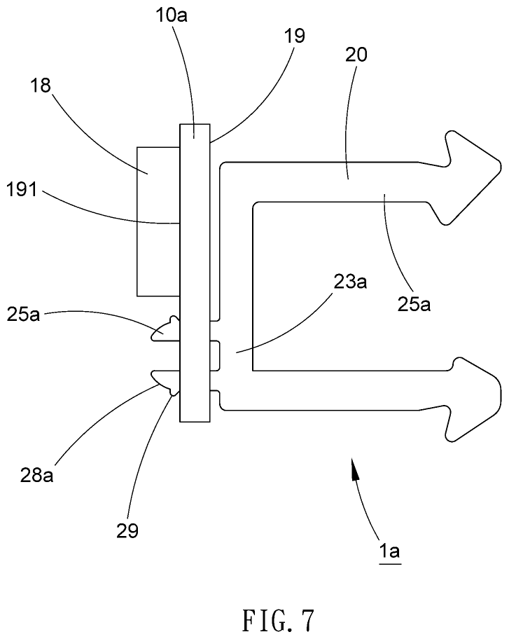

Based on the above-mentioned technical features, various modifications to the structure of the electrical connection structure 1 may be made. For example, FIGS. 5-7 depict an electrical connection structure 1a in accordance with a second embodiment of the present invention, which has a structure basically same as that of the first embodiment, except that the four through holes 14 of the substrate 10 of the first embodiment is modified as only one through hole 14a provided at the substrate 10a of the electrical connection structure 1a in this embodiment. Specifically, the inner peripheral wall of the through hole 14a is provided with a plurality of electrical contacts 16. The two suspension arms 25a of each terminal 20a extend from the connection portion 23a (instead of the two elastic arms 22 of the first embodiment), so that the two elastic arms 22a and the connection portion 23a combined form a U-shaped structure having an opening facing a direction different from that of the first embodiment. The terminal end of the elastic arm 22a of each terminal 20a is provided with a second arc guiding portion 28a, so that the two elastic arms 22a can be smoothly inserted through the through hole 14a. Each of the elastic arms 22a further extends outwards with a stop portion 29. When the two elastic arms 22a extend through the through hole 14a from the first side 19 of the base plate 10a, the two stop portions 29 are abutted against a second side 191 of the substrate 10a opposite to the first side 19. That is, the first side 19 and the second side 191 are located on opposite sides of the substrate 10a. Thereby, the two elastic arms 22a can also be elastically deformed to press against the electrical contacts 16 with elastic rebounding force. The electrical connection structure 1a is not only fast to assemble, and has a stable structure, a high yield rate and low manufacturing cost, but also has the advantage in that the stop portions 29 prevent the terminals 20a from being accidentally escaped from the through hole 14a of the substrate 10a.

More modifications to the structures of the electrical connection structures 1 and 1a may be made. For example, the first and second arc guiding portions 24 and 28a and the stop portions 29 may be omitted. The terminal mount 30 and the retaining mount 40 are used to assist positioning and alignment of the substrate 10 to the terminals 20, such that the structures of the terminal and retaining mounts 30 and 40 may be modified and the terminal and retaining mounts 30 and 40 may be omitted. Such variations are not to be regarded as a departure from the spirit and scope of the invention, and all such modifications as would be obvious to one skilled in the art are intended to be included within the scope of the following claims.

What is claimed is:

1. An electrical connection structure, comprising:
a substrate comprising a through hole and at least one electrical contact provided at a wall of the through hole; and
a terminal comprising two elastic arms spaced from each other, and a connection portion connected with the two elastic arms; the two elastic arms being abutted against the wall of the through hole and electrically connected with the at least one electrical contact.

2. The electrical connection structure as claimed in claim 1, wherein the connection portion of the terminal has an arched shape; the two elastic arms of the terminal extend parallel to each other from two ends of the connection portion.

3. The electrical connection structure as claimed in claim 1, wherein the terminal further comprises two first arc guiding portions; each of the first arc guiding portions is provided at an outer edge of one of two conjunctions where the connection portion is connected with the two elastic arms; the two first arc guiding portions are configured to facilitate insertions of the two elastic arms into the through hole.

4. The electrical connection structure as claimed in claim 1, wherein the terminal further comprises two suspension arms and two contact ends; each of the two suspension arms extends from an end of one of the two elastic arms; each of the two contact ends is provided at a terminal end of one of the two suspension arms.

5. The electrical connection structure as claimed in claim 1, wherein the terminal further comprises two suspension arms extending from the connection portion, and two contact ends; each of the two contact ends is provided at a terminal end of one of the two suspension arms.

6. The electrical connection structure as claimed in claim 1, wherein the terminal further comprises two second arc guiding portions; each of the second arc guiding portions is provided at a terminal end of one of two elastic arms; the two second arc guiding portions are configured to facilitate insertions of the two elastic arms into the through hole.

7. The electrical connection structure as claimed in claim 1, wherein the substrate includes a first side and a second side opposite to the first side; the terminal further comprises two stop portions; each of the two stop portions extends outwardly from one of the two elastic arms; the two elastic arms are inserted through the through hole from the first side toward the second side in a way that the two stop portions are stopped at the second side.

8. The electrical connection structure as claimed in claim 1, wherein the terminal is formed of a sheet piece.

9. The electrical connection structure as claimed in claim 1, wherein the two elastic arms are compressed to deform in a way that at least one of the two elastic arms is elastically pressed against the at least one electrical contact.

10. The electrical connection structure as claimed in claim 1, further comprising a terminal mount to which the terminal is mounted.

11. The electrical connection structure as claimed in claim 10, further comprising a retaining mount connected with the terminal mount in a way that the substrate is sandwiched between the retaining mount and the terminal mount.

12. The electrical connection structure as claimed in claim 11, wherein the terminal mount comprises a plurality of elastic hook arms anchored with the retaining mount.

13. The electrical connection structure as claimed in claim 11, wherein the retaining mount is installed on a toner cartridge.
